(19) United States
(12) Patent Application Publication
(10) Pub. No.: US 2008/0259457 A1
(43) Pub. Date: Oct. 23, 2008

(54) OPTICAL ELEMENT, MASTER PROTOTYPE, RESIN MASTER, RESIN MOLDED ARTICLE AND METAL MOLD

(75) Inventors: Kazuaki Someya, Anpachi-Gun (JP); Yoshiaki Maeno, Mizuho-Shi (JP)

Correspondence Address: DITTHAVONG MORI & STEINER, P.C., 918 Prince St., Alexandria, VA, 22314, US

(73) Assignees: Sanyo Electric Co., Ltd., Moriguchi-shi (JP); Sanyo Optec Design Co., Ltd., Tokyo (JP)

(21) Appl. No.: 12/105,442

(22) Filed: Apr. 18, 2008

(30) Foreign Application Priority Data
Apr. 18, 2007 (JP) 2007-109823

(51) Int. Cl. G02B 5/18

(52) U.S. Cl. 359/572; 249/114.1

(57) ABSTRACT

For generation of optical elements, a master prototype, a resin master, a resin molded article or a metal mold is used. In the master prototype, the resin master, the resin molded article or the metal mold, a fine relief structure is formed on a plane through which an object light is transmitted at a pitch smaller than a wavelength band of the object light, an identification pattern region is disposed in a part of a region where fine relief structure is formed, and in the identification pattern region, a state of the fine relief structure is different from that in the other region. An actual manufacturer of the master prototype, the resin master, the resin molded article or the metal mold can be identified by physically verifying the identification pattern region.

This application claims priority under 35 U.S.C. Section 119 of Japanese Patent Application No. 2007-109823 filed Apr. 18, 2007, entitled “OPTICAL ELEMENT, MASTER PROTOTYPE, RESINMASTER, RESIN MOLDED ARTICLE AND METAL MOLD”.

### BACKGROUND OF THE INVENTION

1. Field of the Invention

The present invention relates to an optical element, and a master prototype, a resin master, a resin molded article and a metal mold for molding the optical element.

2. Description of the Prior Art

In recent years, development in microfabrication techniques has enabled processing in nanometer order. Formation of fine relief structure using such processing techniques allows control of properties of the optical elements. For example, a refraction index of light on an incidence plane can be reduced by forming a fine relief structure on the incidence plane of the light. Thereby, utilization efficiency of the light can improve, and when such an optical element is built into a display device, visibility of an image displayed can improve.

FIG. 13 is a diagram showing a relationship between the fine relief structure and the refraction index. As shown in the drawing, when the fine relief structure is formed, an effective refraction index on a light incidence medium surface gradually varies, resulting in a state as if a boundary of the refraction index is not present between two media. Thereby, a reflectance of the light on the incidence plane is suppressed. This phenomenon occurs when a pitch of the fine relief structure in a direction of the light incidence plane is smaller than a waveform of the light to be used (object light).

FIG. 14 is a diagram showing reflectance properties in the fine relief structure. In the drawing, the reflectance properties are shown in two cases: one is a case where a dielectric multi-layered film is formed on the light incidence plane, and another is a case where a simple planar plane is provided with nothing formed thereon.

As illustrated, when the fine relief structure is formed in the optical element, the reflectance can be suppressed over a wider waveband as compared to the case where the dielectric multi-layered film is formed. Since the fine relief structure can be formed by nanoimprinting or the like, advantageously, the fine relief structure allows reduction of costs as compared to the case of the dielectric multi-layered film.

The fine relief structure is usually formed using a metal mold for transfer. Various steps such as application of microfabrication techniques are necessary until the metal mold is obtained, thereby consuming considerable labors and costs. However, once the metal mold is generated, the fine relief structure is transferred from the metal mold and thus duplication of the metal mold can be carried out with comparative ease. Furthermore, the metal mold can be duplicated from the optical element, a master prototype, or the like as well as the metal mold, using transfer techniques. When such duplication is attempted without permission, costs of metal mold producers are wasted while bringing unfair profits to those who contrive illegal duplication.

### SUMMARY OF THE INVENTION

The present invention has been developed to remove above-mentioned problems and an object of the present invention is to reasonably suppress unauthorized duplication of metal molds or optical elements.

A first aspect of the present invention relates to an optical element. The optical element includes a fine relief structure being formed in a plane through which an object light is transmitted with a pitch smaller than a wavelength band of the object light. The optical element has an identification pattern region in a part of a region where the fine relief structure is formed, and in the identification pattern region a state of forming the fine relief structure is different from that of other part of the region.

A second aspect of the present invention relates to a master prototype used for generating an optical element. The master prototype includes a transfer pattern for transferring and forming a fine relief structure to the optical element. The fine relief structure is transferred and formed directly or through other intermediate product from the transfer pattern on a plane through which an object light for the optical element is transmitted in the optical element. The fine relief structure has a pitch smaller than a wavelength band of the object light. Further, an identification pattern region is arranged in a part of a region where the fine relief structure is formed, in the identification pattern region, a state of formation of the fine relief structure being different from that in other region.

A third aspect of the present invention relates to a resign master used for generating an optical element. The resinmaster includes a transfer pattern for transferring and forming a fine relief structure to the optical element. The fine relief structure is transferred and formed directly or through other intermediate product from the transfer pattern on a plane through which an object light for the optical element is transmitted in the optical element. The fine relief structure has a pitch smaller than a wavelength band of the object light. Further, an identification pattern region is arranged in a part of a region where the fine relief structure is formed, in the identification pattern region, a state of formation of the fine relief structure being different from that in other region.

The resin master according to the third aspect is generated from the master prototype as an intermediate product through steps of generating a metal mold. In general, a pattern of the master prototype is transferred to the resin master and the pattern of the resin master is transferred to a metal mold to generate the metal mold.

A fourth aspect of the present invention relates to a resin molded article used for generating an optical element. The resin molded article includes a transfer pattern for transferring and forming a fine relief structure to the optical element. The fine relief structure is transferred and formed directly or through other intermediate product from the transfer pattern on a plane through which an object light for the optical element is transmitted in the optical element. The fine relief structure has a pitch smaller than a wavelength band of the object light. Further, an identification pattern region is arranged in a part of a region where the fine relief structure is formed, in the identification pattern region, a state of formation of the fine relief structure being different from that in other region.

The resin molded article according to the forth aspect denotes a product made of resin materials. The resin molded article according to the forth aspect includes an intermediate product such as the resin master and a final product such as the optical element, and may include products made of resin materials other than the resin master and the optical element. In other words, the resin molded article according to the forth aspect includes above-mentioned transfer pattern and includes molded articles in any form made of resin materials in a broad sense and capable of generating the optical element using the transfer pattern. In the following embodiments, the resin master and the optical element correspond to the resin molded article according to the forth aspect.

A fifth aspect of the present invention relates to a metal mold used for generating an optical element. The metal mold includes a transfer pattern for transferring and forming a fine relief structure to the optical element. The fine relief structure is transferred and formed directly from the transfer pattern on a plane through which an object light for the optical element is transmitted in the optical element. The fine relief structure has a pitch smaller than a wavelength band of the object light. Further, an identification pattern region is arranged in a part of a region where the fine relief structure is formed, in the identification pattern region, a state of formation of the fine relief structure being different from that in other region.

According to the invention according to each of above-mentioned aspects, by physically verifying the identification pattern region of an optical element, it is possible to identify an actual manufacturer of the optical element or the metal mold or the like used for generation thereof. Therefore, when the optical element or metal mold or the like are generated by unauthorized duplication, it is possible to find the fact surely and smoothly, thereby suppressing such unauthorized duplication.

### BRIEF DESCRIPTION OF THE DRAWINGS

The object and novel features of the present invention will be fully understood by reading description of embodiments together with attached drawings as shown below.

FIGS. 1A through 1C show an outline of steps for forming an optical element according to the embodiments;

FIG. 2 shows steps for forming a master prototype according to the embodiments;

FIG. 3 shows an optical system used for drawing a fine relief structure according to the embodiments;

FIG. 4 shows steps for forming a resin master structure according to the embodiments;

FIG. 5 shows steps for forming a metal mold according to the embodiments;

FIG. 6 shows steps for forming a Ni-layer according to the embodiments;

FIGS. 7A through 7C are diagrams for explanation of states of forming an identification pattern region according to Example 1;

FIGS. 8A and 8B show examples of forming an identification pattern region according to Embodiment 1;

FIGS. 9A and 9B show examples of forming an identification pattern region according to Embodiment 1;

FIGS. 10A and 10B show examples of forming an identification pattern region according to Embodiment 1;

FIGS. 11A through 11D are diagrams for explanation of states of forming an identification pattern region according to Embodiment 2;

FIGS. 12A and 12B show examples of forming an identification pattern region according to Embodiment 2;

FIG. 13 is a diagram for explanation of non-reflecting properties of the fine relief structure; and

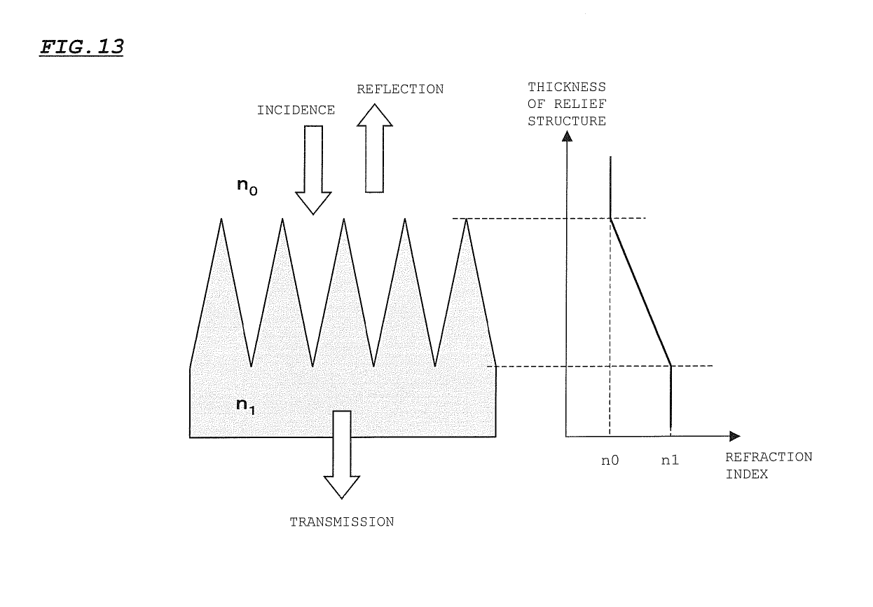

FIG. 14 is a diagram for explanation of the non-reflecting properties of the fine relief structure.

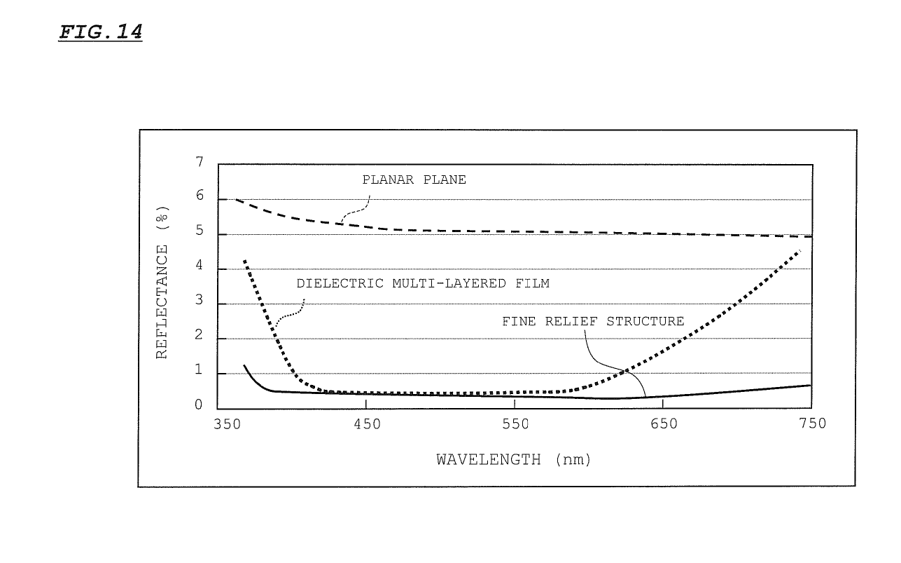

However, the drawings are illustrative and only for explanation and do not limit the scope of the present invention.

### DESCRIPTION OF PREFERRED EMBODIMENTS

Referring now to the drawings, embodiments according to the present invention will be explained hereinafter.

Referring now to the drawings, the embodiments according to the present invention will be explained hereinafter. The embodiments according to the present invention are applied to an optical element (cover member) having a flat plate shape assembled into a display device, a master prototype and a metal mold or the like used to generate the optical element.

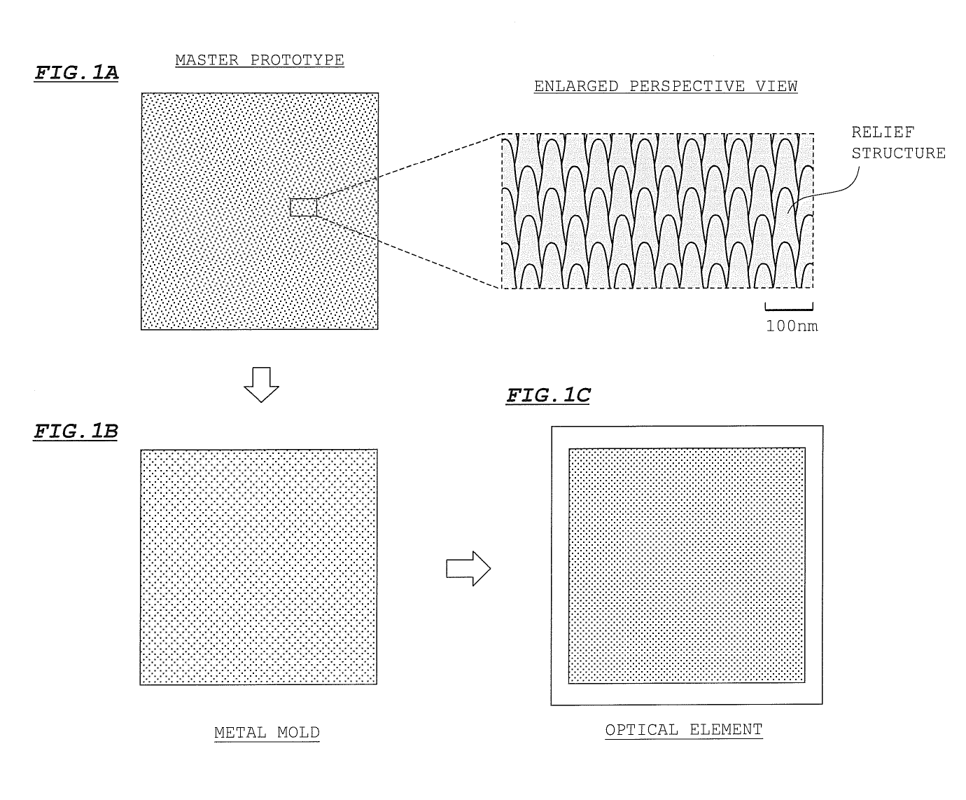

A configuration of the master prototype according to the embodiment is shown in FIG. 1A. A fine relief structure is formed in the master prototype at a constant pitch as illustrated in an enlarged perspective view. The pitch of the fine relief structure is, for example, approximately 100 nm. A height of the fine relief structure is approximately 200 nm.

A metal mold for resin molding is generated from the master prototype (see FIG. 1B). Then, using the metal mold, the optical element is generated by, for example, nanoimprinting (see FIG. 1C). According to the present embodiment, the metal mold is not generated directly from the master prototype, but a resin master is once generated and then the metal mold is generated from the resin master.

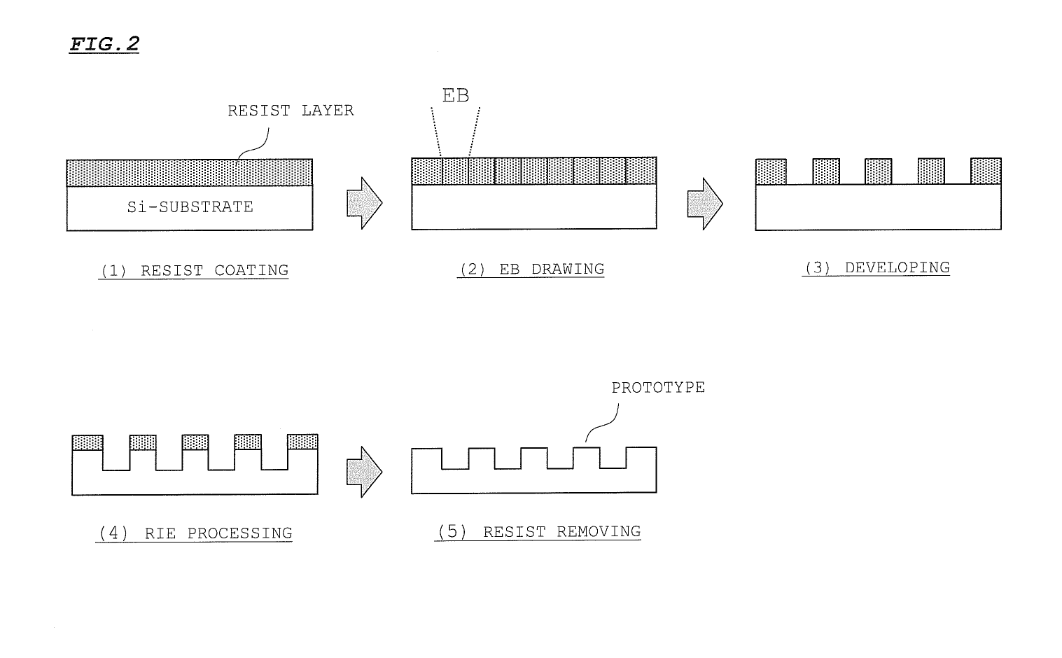

FIG. 2 is a diagram showing steps for generating the master prototype by electron beam cutting.

In the generation steps, first, a resist is applied to a silicone substrate by spin coating (Step 1). The resist used here is an electronic beam resist. Following this, a fine relief structure with the above-mentioned pitch is drawn by EB drawing (electron beam cutting) (Step 2). Then, development processing is performed (Step 3) and RIE processing is further performed (Step 4). After that, a residual resist is removed by oxygen plasma ashing (Step 5). Thus, the fine relief structure is formed on the silicone substrate, completing generation of the master prototype.

Drawing of the fine relief structure on the resist may be carried out using a laser beam in lieu of an EB (electron beam). Furthermore, the fine relief structure can be drawn on the resist by exposing the resist while interfering two light beams with each other (2-light flux interference exposure method).

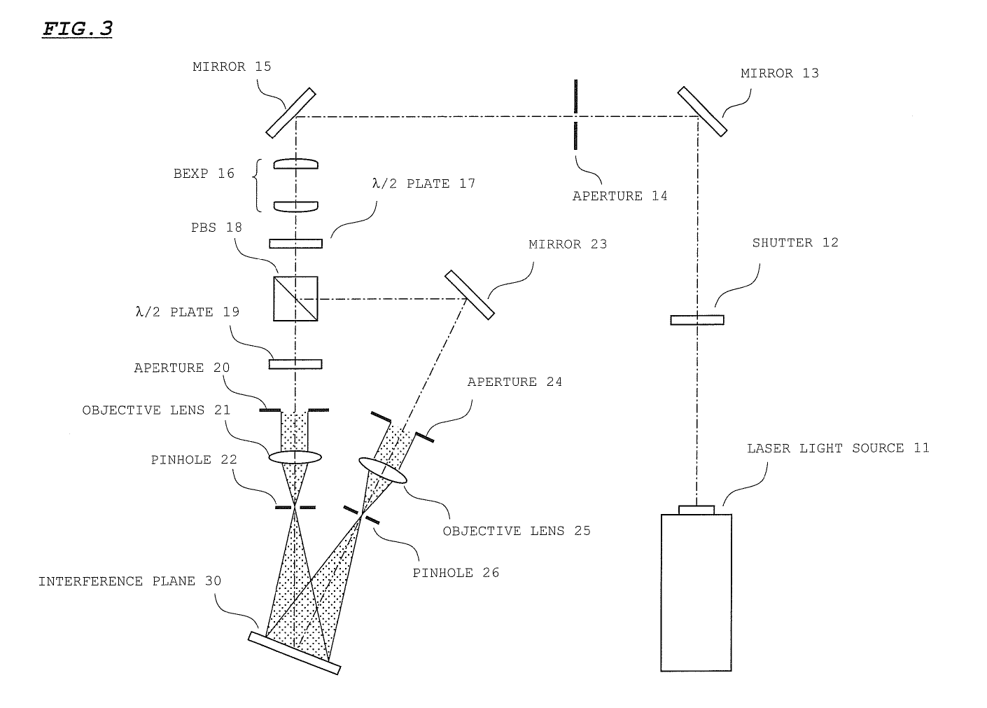

FIG. 3 is a diagram showing an example of a configuration of an optical system used in the 2-light flux interference exposure method.

In the drawing, light emitted from a laser light source 11 is entered to a beam expander (BEXP) 16 via a shutter 12, a mirror 13, an aperture 14, and a mirror 15, and is converted to parallel light in a certain shape. Following this, a polarization direction of the laser light with regard to a polarization beam splitter (PBS) 18 is adjusted by a λ/2 plate 17. Then, the laser light is branched into two light fluxes by the PBS 18.

The laser light (a first laser light) transmitted through the PBS 18 is further transmitted through a λ/2 plate 19, and a direction of polarization of the first laser light is then turned by 90 degrees. Then, the direction of polarization of the first laser light is aligned with a direction of polarization of the laser light (a second laser light) reflected by the PBS 18. Following this, the first laser light is entered to an objective lens 21 via an aperture 20 and is converged with a predetermined numerical aperture. After that, the first laser light passes through a pinhole 22 and is irradiated onto an interference plane 30.

The second laser light reflected by the PBS 18 is entered to an objective lens 25 via a mirror 23 and an aperture 24 and is converged with a predetermined numerical aperture. After that, the second laser light passes through a pinhole 26 and is irradiated onto interference plane 30.

On the interference plane 30, interference fringes having a stripe form are generated due to interference of the first laser light and the second laser light. A pitch of stripes can be adjusted by incident angles of the first laser light and the second laser light with regard to the interference plane 30.

Exposure in accordance with the interference fringes can be made by disposing a silicone substrate to which a resist is applied on the interference plane 30. A one-dimensional stripe structure is drawn on the resist by first exposure, and a two-dimensional pyramid structure is drawn onto the resist by second exposure after the silicone substrate is turned in an in-plane direction by 90 degrees. Then, the fine relief structure is drawn on the resist with a similar manner as in the case shown in FIG. 2. Following this, the master prototype with the fine relief structure on the silicone substrate is generated by performing Steps 3, 4, and 5 shown in FIG. 2.

When the fine relief structure on the master prototype are formed into a metal mold by electroforming, such a method is generally employed that the master prototype is removed by melting after electroforming for prevention of destruction of the fine relief structure. However, a method used in the present embodiment is such that the metal mold is not generated directly from the master prototype, but a resin master is once generated and the metal mold is generated from the master.

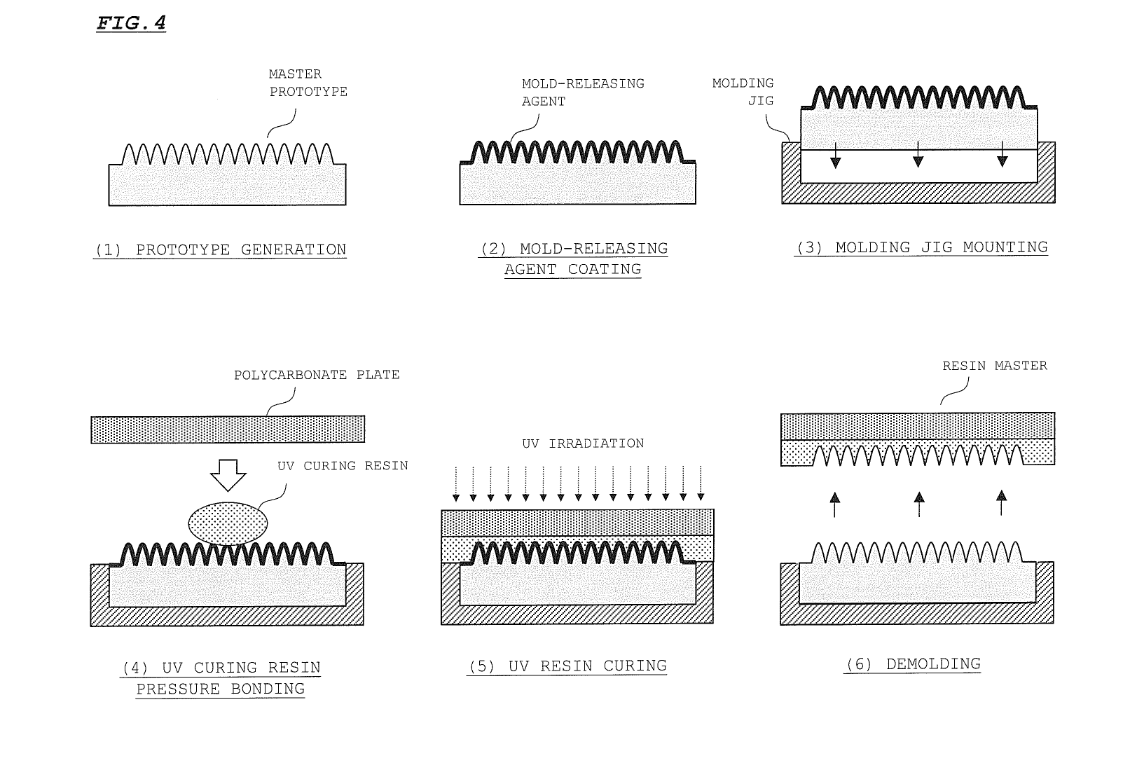

FIG. 4 is a diagram showing steps for generating the resin master from the master prototype.

In the generation steps, first, a fluorine-based mold-releasing agent is applied to the fine relief structure (Step 2), and then the master prototype is mounted on a molding jig (Step 3). After that, an ultraviolet curing resin in a liquid state is dropped on the fine relief structure, a transparent substrate (a plate made of a polycarbonate used in the optical disks or the like) with high ultraviolet transmissivity is placed on the fine relief structure, and the transparent substrate is pressed against the master prototype (Step 4). Then, the ultraviolet curing resin is embedded among projections and depressions of the fine relief structure. After the pressure bonding step is performed for a predetermined period of time, ultraviolet rays are irradiated from the transparent substrate side to cure the ultraviolet curing resin (Step 5). After that, the cured ultraviolet curing resin is peeled off from the master prototype together with the transparent substrate (Step 6). Then, the resin master is generated.

For the generated resin master, a state of formation of the fine relief structure is observed and evaluated for using an atom force microscope. When the observation and evaluation show that the state of formation of the fine relief structure is appropriate, the generated resin master is recognized as a completed article.

Using the generated resin master, the metal mold is generated.

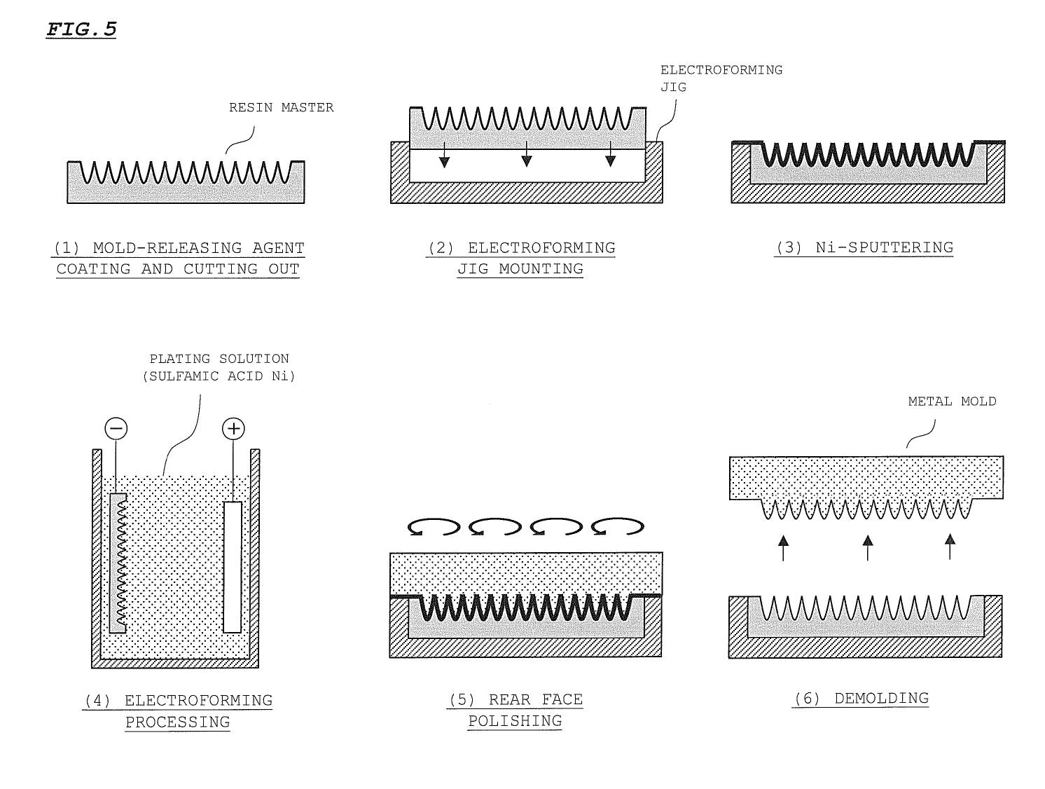

FIG. 5 is a diagram showing steps for generating the metal mold. In the generation steps, the mold-releasing agent is applied to the resin master generated as mentioned above and the resin master is cut out so as to be aligned with a shape of an electroforming jig (Step 1). Here, since the resin master is made of the ultraviolet curing resin as mentioned, the mold-releasing agent cannot be applied to the resin master as it is. Therefore, at Step 1, a dielectric body having an OH-group is sputtered on the fine relief structure and then the mold-releasing agent is applied thereto.

Subsequently, the resin master cut out is mounted on the electroforming jig (Step 2) and the Ni-layer is further formed on the fine relief structure by sputtering (Step 3). Following this, the resin master mounted on the electroforming jig is immersed in a plating solution to deposit an additional Ni-layer onto the Ni-layer (Step 4). The processing is performed until a thickness of the Ni-layer reaches a predetermined thickness. After that, the resin master mounted on the electroforming jig is pulled out from the plating solution and the rear face of the Ni-layer is polished before the Ni-layer formed is peeled off from the resin master (Step 5). Following this, the Ni-layer is peeled off from the resin master (Step 6) thereby generating the metal mold.

For the generated metal mold, a state of formation of the fine relief structure is observed and evaluated for using the atom force microscope. When the observation and evaluation show that the state of formation of the fine relief structure is appropriate, the generated resin master is recognized as a completed article.

In the generation steps shown in FIG. 5, the Ni-layer is generated by the two steps of sputtering and electroforming. The Ni-layer deposited by sputtering plays a role of an electrode in the electroforming step. From this point of view, the Ni-layer formed in a form of a film (film thickness is approximately several hundred of Å) on the surface of the fine relief structure by sputtering will be enough. However, when the fine relief structure is formed with a pitch in nanometer order as is the case of the present embodiment, the projections and depressions of the fine relief structure cannot be filled with the Ni-layer unless electroforming processing is carried out with a current density at a considerably low level. Therefore, when the Ni-layer is formed on the surface of the fine relief structures in the form of the film by sputtering, time needed for electroforming becomes relatively long and metal mold generation efficiency is reduced remarkably.

This problem is eliminated by forming the Ni-layer, by sputtering, on the surface of the fine relief structure, and forming the Ni-layer until the projections and depressions of the fine relief structure are filled to a certain extent.

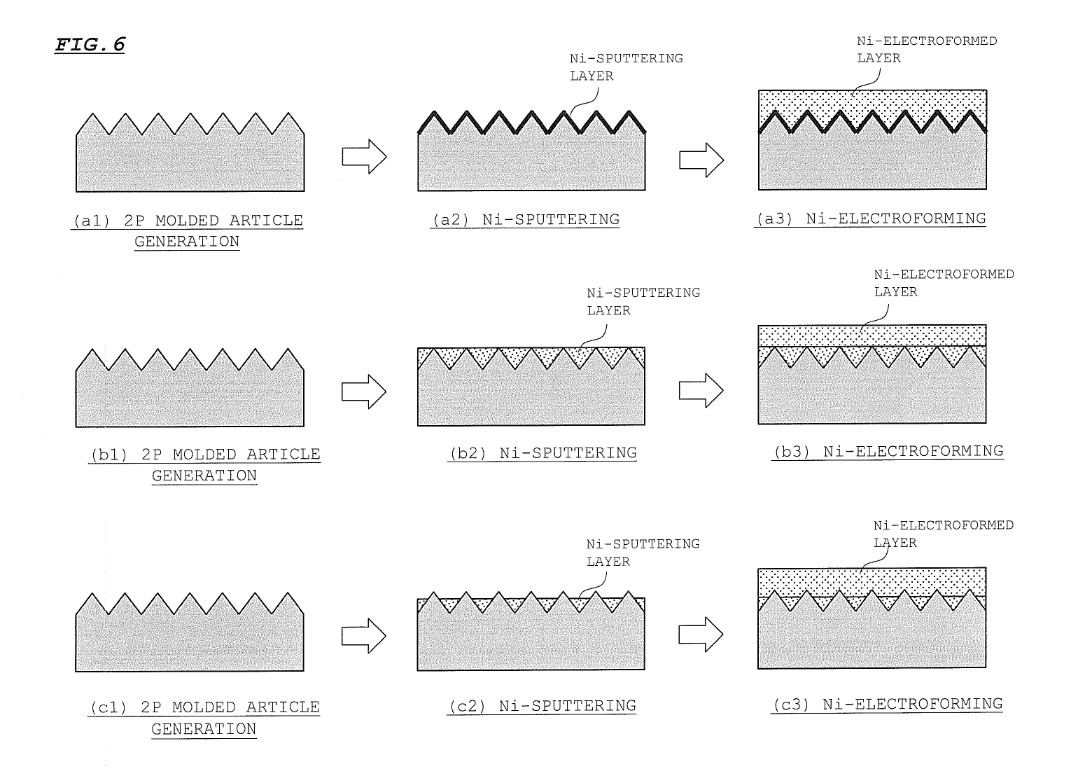

FIG. 6 is a diagram showing a flow from a step of forming the Ni-layer by sputtering to a step of forming the Ni-layer by electro forming. In FIG. 6, the steps (a-1), (a-2), and (a-3) show a flow in the case where the Ni-layer is formed, by sputtering, only on the surface of the fine relief structure. Furthermore, the steps (b-1), (b-2), and (b-3) in FIG. 6 show a flow in the case where the Ni-layer is formed, by sputtering, on the surface of the fine relief structure, and forming the Ni-layer until the projections and depressions of the fine relief structure are filled up thoroughly, and the steps (c-1), (c-2), and (c-3) in FIG. 6 show a case where the Ni-layer is formed, by sputtering, on the surface of the fine relief structure, and forming the Ni-layer until the projections and depressions of the fine relief structure are filled to a certain depth.

At the steps (a-1), (a-2), and (a-3) in FIG. 6, the projections and depressions of the fine relief structure cannot be filled with the Ni-layer unless electroforming processing is carried out with the current density at the considerably low level as mentioned above, and for this reason, time needed for electroforming becomes relatively long.

To the contrary, at the steps (b-1), (b-2), and (b-3) in FIG. 6, while time for processing step by sputtering becomes longer as compared to that at the steps (a-1), (a-2), and (a-3) in FIG. 6, electroforming processing can be carried out at a faster speed since electroforming processing can be carried out with an increased current density, and total time needed for Ni-layer formation is remarkably reduced than that at the steps (a-1), (a-2), and (a-3) in FIG. 6.

Furthermore, at the steps (c-1), (c-2), and (c-3) in FIG. 6, while time for electroforming processing becomes longer as compared to that at the steps (b-1), (b-2), and (b-3) in FIG. 6, time needed for electroforming processing is reduced considerably as compared to that at the steps (a-1), (a-2), and (a-3) in FIG. 6, and total time needed for Ni-layer formation is reduced than that at the steps (a-1), (a-2), and (a-3) in FIG. 6.

At the steps (b-1), (b-2), and (b-3), and at the steps (c-1), (c-2), and (c-3) in FIG. 6, an electric resistance of the Ni-layer in the electroforming processing is reduced due to an increased thickness of the Ni-layer by sputtering. The Ni-layer by sputtering is formed on the fine relief structure in every hole and corner, and advantageously, electroforming processing can be performed in a stable fashion as compared to the case at the steps (a-1), (a-2), and (a-3) in FIG. 6. Furthermore, transfer properties of the fine relief structure to the Ni-layer can be improved compared to those at the steps (a-1), (a-2), and (a-3) in FIG. 6.

At the steps (b-1), (b-2), and (b-3) in FIG. 6, while such a method is used that the Ni-layer is formed by sputtering until the projections and depressions of the fine relief structure are filled up thoroughly, an additional Ni-layer may be formed by sputtering to a predetermined thickness even after the projections and depressions of the fine relief structure are filled up thoroughly. Furthermore, while such a method is used at the steps (c-1), (c-2), and (c-3) in FIG. 6 that the Ni-layer is formed by sputtering to a certain depth in the projections and depressions of the relief structure, an extent of the depth of the Ni-layer formed by sputtering may be appropriately set depending on an area or the like of the fine relief structure.

For example, as the area of the fine relief structure becomes greater, it is more difficult to deposit the Ni-layer at the center of the relief structure region. Therefore, the depth of the Ni-layer by sputtering is made deeper, the projections and depressions of the fine relief structure are filled up thoroughly, or the additional Ni-layer is formed by sputtering after the projections and depressions of the fine relief structure are filled up thoroughly. To the contrary, when the area of the fine relief structure is smaller, the Ni-layer can be comparatively easily deposited at the center of the relief structure region. Therefore, the depth of the Ni-layer by sputtering is made shallower, or the Ni-layer by sputtering is formed only on the surface of the fine relief structure.

Using the metal mold generated as mentioned, optical elements are resin molded. Here, the optical elements are generated by, for example, nanoimprinting. In addition, the optical elements can be generated by 2P molding shown in FIG. 4, cast molding, resin thermoforming, and heat press molding, or the like. While metal molds are generated from the resin master in the above-mentioned embodiment, generation of the metal mold directly from the master prototype is of course possible. However, in this case, there is a possibility that the fine relief structure on the master prototype might be broken when generating the metal mold.

### Embodiment 1

According to the present embodiment, an identification pattern region is formed when the master prototype is generated.

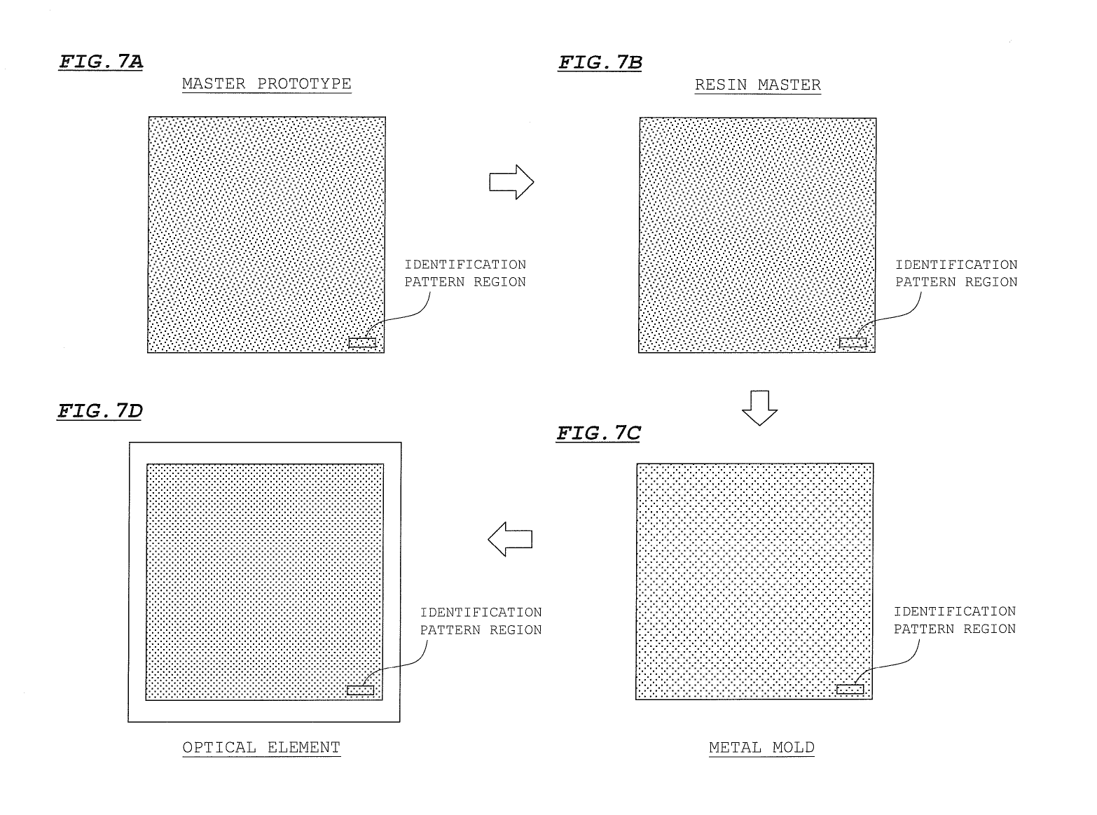

As shown in FIG. 7A, according to the present embodiment, the identification pattern region is set in a peripheral region that hardly gives influences on looking and listening. A state of formation of the fine relief structure in the identification pattern region is different from that of other region. In the above-mentioned generation steps shown in FIG. 4, the identification pattern region is transferred from the master prototype to the resin master together with the other region (see FIG. 7B). Furthermore, in the above-mentioned generation steps shown in FIG. 5, the identification pattern region is transferred from the resin master to the metal mold together with the other region (see FIG. 7C), and transferred from the metal mold to the optical element at an optical element molding step (see FIG. 7D).

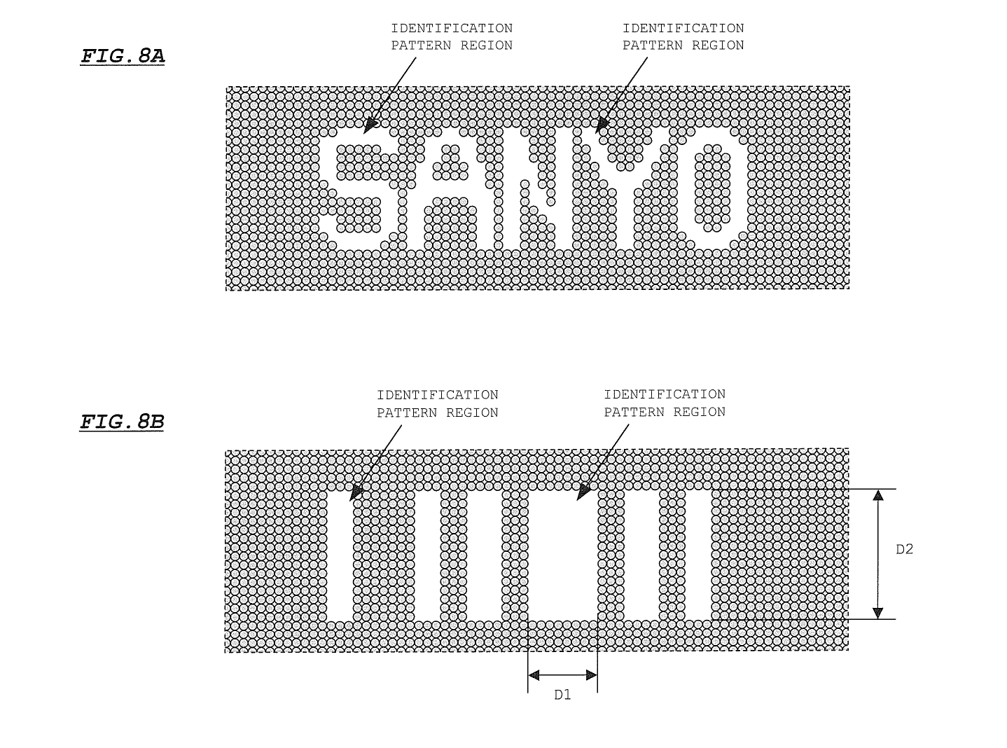

FIGS. 8A and 8B are diagrams showing examples of formation of the identification pattern region. FIGS. 8A and 8B are diagrams showing the master prototype viewed from a direction vertical to the plane on which the fine relief structures are formed. A gray circle in the drawing schematically shows one projection (structure) of the fine relief structure.

In the example of construction shown in FIG. 8A, the identification pattern region is formed by defining two structures as a width and removing structures a diagrammatic fashion. Furthermore, in the example of a configuration shown in FIG. 8B, the identification pattern region is formed by defining a predetermined number of structures as the width and removing a certain number of structures in a longitudinal direction. Here, the identification pattern region is formed, for example, by controlling a drawing pattern at EB drawing at Step 2 in FIG. 2.

According to the example of the configuration, the width of the identification pattern region is set to be a size not more than a recognition limit of human eyes. As mentioned above, it is said that human eyes can distinguish articles and pictorial figures up to several tens of μm. Therefore, when the width of the identification pattern is the size not more than the recognition limit of human eyes, and when optical properties of the identification pattern region are different from optical properties of the other region, the differences would not be distinguished by human eyes. Although the recognition limit of human eyes varies somewhat depending on individuals, when the width of the identification pattern region is not more than 100 μm, usually, the identification pattern region cannot be, or hardly can be, distinguished. More preferably, when the width of the identification pattern region is not more than 10 μm, users are unable to distinguish the identification pattern region even when the identification pattern region is formed.

As shown in FIG. 8B, the width of the identification pattern region is present longitudinally and transversely, and in this case, the smaller width D1 needs to be not more than the recognition limit of human eyes. Accordingly, in the example shown in FIG. 8B, at least the width D1 is set to be not more than 100 μm, and more preferably, both of the widths D1 and D2 are set to be not more than 100 μm. Still more preferably, the width D1, or both of the widths D1 and D2 are set to be not more than 10 μm.

By setting the width of the identification pattern region as mentioned, verification of the actual manufacturer can be made by the identification pattern region while influences of the identification pattern region for the visibility are suppressed.

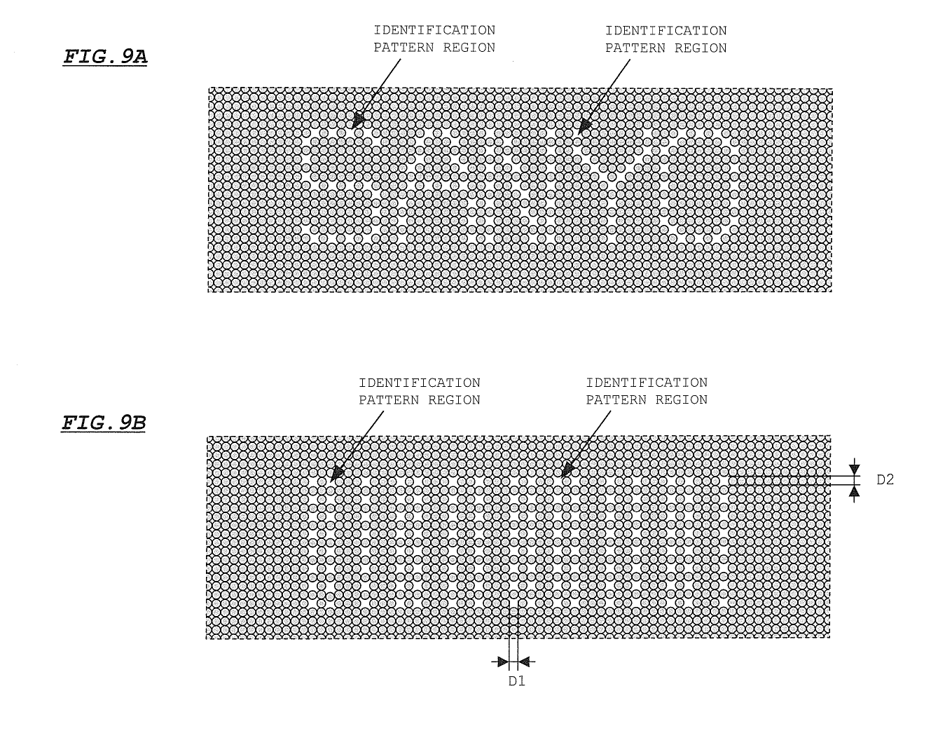

FIGS. 9A and 9B are diagrams showing other examples of formation of the identification pattern region. While, in the above-mentioned embodiment, the cover member having a flat plate shape to be assembled to the display device is assumed as the optical element, the examples shown in FIGS. 9A and 9B are preferably used when optical elements or the like constituting an optical system of an optical pick-up device are formed according to the steps shown in the above-mentioned embodiment.

In the examples of formation shown in FIGS. 9A and 9B, the widths of the identification pattern region are smaller than those shown in FIGS. 8A and 8B. That is, in the examples of configuration, the identification pattern region is formed by removing one structure. Similarly to the cases in FIGS. 8A and 8B, the identification pattern region is formed by controlling the drawing pattern at EB drawing at Step 2 shown in FIG. 2.

When portions of the fine relief structures are missing with a width greater than a wavelength band of the object light, or when a height of the portions of the fine relief structure contained in the width is different from other portions of the fine relief structure, the width portions cannot appropriately demonstrate original optical properties to be demonstrated by the other region of the fine relief structure. Therefore, when the width of the identification pattern region is set to be not more than the wavelength band of the object light, verification by the identification pattern can be performed by the identification pattern without deteriorating the original optical properties.

As mentioned, even when the portions of the fine relief structures are missing with a width greater than a wavelength band of the object light, or when a height of the portions of the fine relief structure contained in the width is different from other portions of the fine relief structure, the optical properties of the width portions will not greatly differ from the original optical properties to be demonstrated by the other region of the fine relief structure. Accordingly, when the optical element formed according to the steps shown in the above-mentioned embodiment is assembled to, for example, an optical pick-up device, and when the identification pattern region is formed with a width not more than a wavelength of a laser used in the optical pick-up device, influences of the identification pattern region with regard to the original optical properties of the other region of the fine relief structure can be suppressed. For example, when the wavelength of the laser used is approximately 450 nm, the original optical properties (e.g., nonreflecting properties) of the fine relief structure formed in the optical element are fairly demonstrated by setting the width of the identification pattern region to be smaller than the wavelength of the laser.

As shown in FIG. 8B, the width of the identification pattern region is present longitudinally and transversely, and in this case, both of the widths D1 and D2 are set to be not more than the wavelength of the laser used. For example, when the pitch of the fine relief structure is set to be approximately 100 nm, and when the identification pattern region is formed by removing one structure in the dot-shape as shown in FIGS. 9A and 9B, the widths D1 and D2 of the identification pattern region become approximately 100 nm, and the widths are approximately ¼ of the wavelength of the laser used (450 nm). Therefore, when the identification pattern region is formed as shown in FIGS. 8A and 8B, verification of the actual manufacturer can be performed by the identification pattern without deteriorating the original optical properties of the fine relief structure.

While one structure is removed in the dot-shape in the examples of formation shown in FIGS. 9A and 9B, when both of the widths D1 and D2 are not more than the wavelength band of the laser used, the same effect as in the cases shown in FIGS. 9A and 9B are attained even when the identification pattern region is formed by removing a plurality of continuous structures.

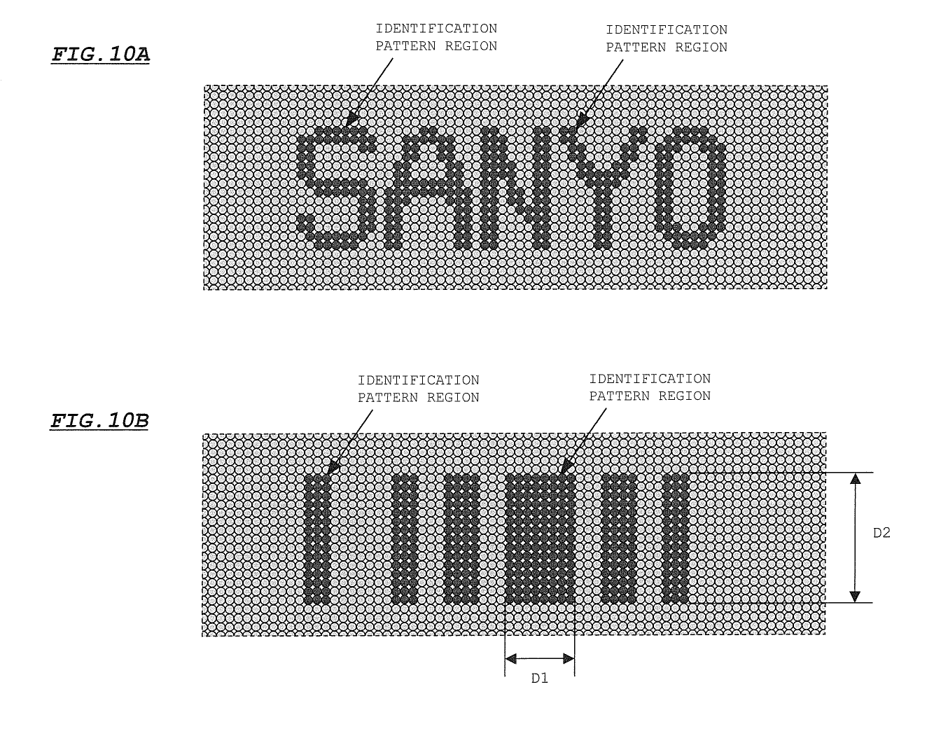

FIGS. 10A and 10B are diagrams showing other examples of formation of the identification pattern region. In the above-mentioned examples of formation shown in FIGS. 8A and 8B, the identification pattern region is formed by removing the structures of fine relief structure, while in the examples of formation shown in FIGS. 10A and 10B, the identification pattern region is formed by changing a height of the structure in the identification pattern region with respect to that in the other region. Here, the height of the structure is adjusted, for example, by controlling an amount of dose at EB drawing at Step 2 in FIG. 2. The greater the amount of dose is irradiated, the deeper grooves are drawn onto the resist, and the smaller the dose amount is, the shallower grooves are drawn. Therefore, the height of the structure in the identification pattern region can be made different from that in the other region by giving a different irradiation density of the amount of dose or irradiation time in the identification pattern region from that in the other region.

The same effect as the cases in the above-mentioned examples of formation in FIGS. 8A and 8B is also attained in the examples of formation depicted in FIGS. 10A and 10B. Furthermore, also in the examples of formation depicted in FIGS. 9A and 9B, the identification pattern region can be formed by changing the height of the structure in the identification pattern region with respect to that in the other region. The same effect as the case in the above-mentioned examples of formation depicted in FIGS. 9A and 9B is also attained in this case.

In the present embodiment, a pattern drawn in the identification pattern region is a pattern specific to an actual manufacturer of the master prototype. Therefore, it is possible to identify the actual manufacturer of the master prototype through physical observation of a region corresponding to the identification pattern region and judgment of the pattern acquired from the observation. Similarly, physical observation of the region corresponding to the identification pattern regions of the resin master, the metal mold, and the optical element allows identification of the manufacturer of the master prototype from which the resin master, the metal mold, or the optical element has been generated.

Observation of the identification pattern region can be made using the atom force microscope and the like. When the region corresponding to the identification pattern region is scanned by the atom force microscope, a signal with amplitude according to the projections and depressions of the fine relief structure is obtained. A pattern retained in the identification pattern region is obtained through arithmetic processing of the signals obtained when all the regions corresponding to the identification pattern region are scanned. When the pattern is obtained from the master prototype, the actual manufacturer of the master prototype can be identified, and when the pattern is obtained from the resin master, the metal mold, or the optical element, it is possible to identify the manufacturer of the master prototype from which the resin master, the metal mold, or the optical element has been generated.

### Embodiment 2

According to the present embodiment, the identification pattern region is formed after the master prototype is generated.

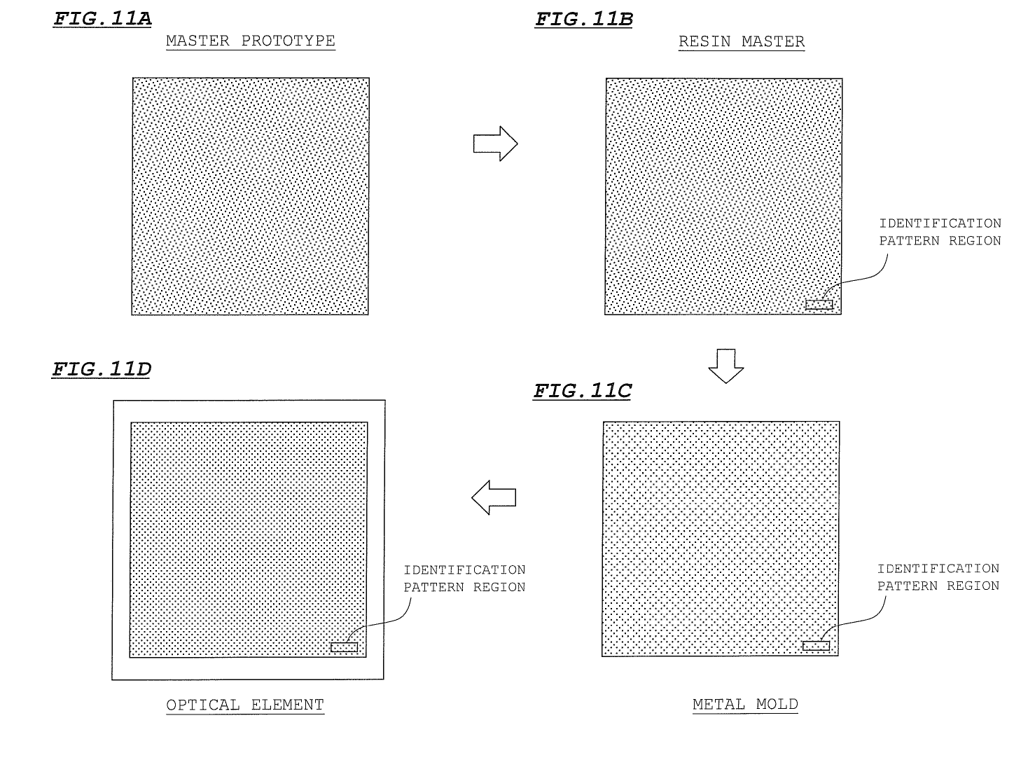

That is, as shown in FIG. 11A, in the present embodiment, the identification pattern region is not generated in the master prototype. The identification pattern region is generated, for example, when the resin master is generated (see FIG. 11B)

In the same fashion as the case in the above-mentioned Embodiment 1, the state of formation of the fine relief structure in the identification pattern region is different from that in the other region. The identification pattern region is transferred from the resin master to the metal mold together with the other region in the above-mentioned generation steps shown in FIG. 5 (see FIG. 11C). Furthermore, transfer from the metal mold to the optical element is performed during formation of the optical element (see FIG. 11D).

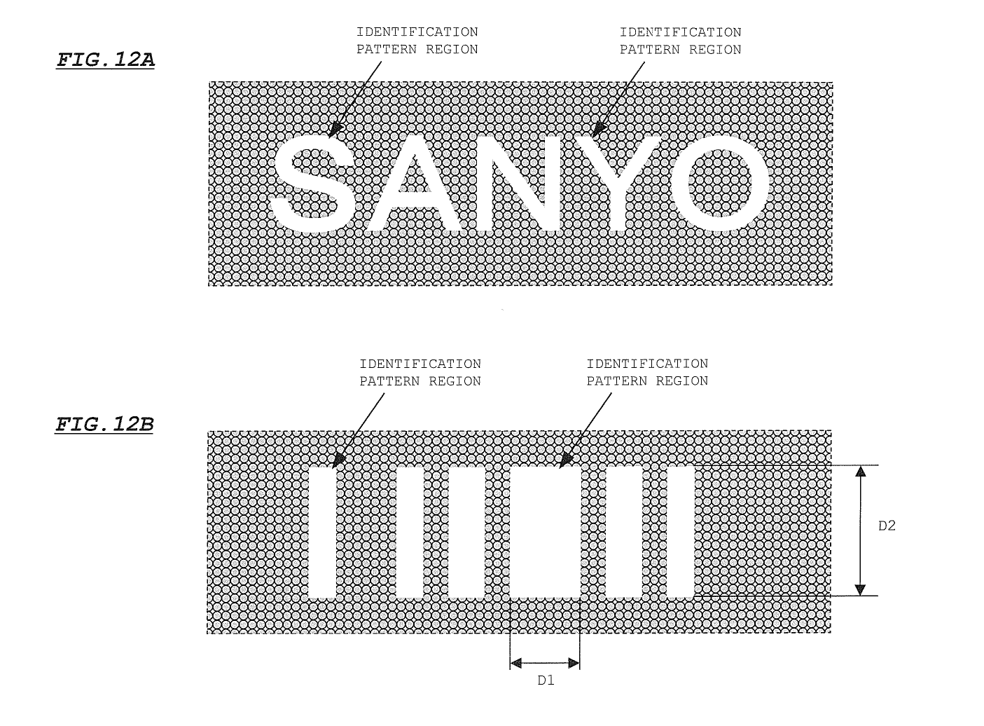

FIGS. 12A and 12B are diagrams showing examples of formation of the identification pattern region. FIGS. 12A and 12B are diagrams showing the resin master viewed from a direction vertical to the plane on which the fine relief structure is formed. A gray circle in the drawing schematically denotes one projection (structure) of the fine relief structure.

In the example of a configuration shown in FIG. 12A, the identification pattern region is formed by removing the structure in a diagrammatic fashion with a certain width. In the example of configuration shown in FIG. 12B, the identification pattern region is formed by removing the structure by a certain length in a longitudinal direction with a predetermined width.

Here, the identification pattern region is formed by pulling and cutting the structure of the fine relief structure using, for example, an ultra-precision processing machine capable of processing in nanometer order. For the ultra-precision processing machine, for example, “ROBONANO α-OiB” (“ROBONANO” is the trademark of FANUC LTD.) may be used.

In the examples of formation shown in FIGS. 12A and 12B, influences of the identification pattern region with regard to visibility can be suppressed by setting the widths D1 and D2 of the identification pattern region similarly to those in the examples of formation shown in FIGS. 8A and 8B.

Furthermore, it is possible to form the identification pattern region in the dot-shape in the same manner as that shown in FIGS. 9A and 9B. It is also possible to form the identification pattern region by changing the height of the structure in the identification pattern region with respect to that in the other region in the same manner as in the cases shown in FIGS. 10A and 10B. The same effect is also attained in this case as is the cases of FIGS. 9A and 9B, and FIGS. 10A and 10B.

In addition, in the present embodiment, the identification pattern region can be formed by excavating the identification pattern region deeper than the bottom part of the structure. Since the above-mentioned ultra-precision processing machine manufactured by FANUC LTD. can control the height to be pulled and cut, it is possible to adjust the height of the structure in the identification pattern region or to excavate deeper than the bottom part of the structure when pulling and cutting the structure.

Observation of the identification pattern region can be made using, for example, the atom force microscope in the same manner as in the cases of the above-mentioned Embodiment 1. By this observation, a pattern retained in the identification pattern region can be obtained from the resin master, the metal mold or the optical element. When the pattern is obtained from the resin master, the actual manufacturer can be identified, and when the pattern is obtained from the metal mold or the optical element, it is possible to identify the manufacturer of the resin master from which the metal mold or the optical element has been generated.

In the present embodiment, while the identification pattern region is formed in the resin master, the identification pattern region may be formed in the metal mold or in a molded article resin molded from the metal mold. Also in this case, the identification pattern region can be formed by pulling and cutting the structure of the fine relief structure by the ultra-precision processing machine in the same manner as mentioned above.

As mentioned above, according to Embodiment 1 and Embodiment 2, the actual manufacturer of the master prototype, the resin master and the metal mold can be identified through physical observation of the identification pattern region. Therefore, when the optical elements or the metal molds, or the like are generated as unauthorized duplication, the fact can be found surely and smoothly, thereby suppressing such unauthorized duplication.

In the above-mentioned Embodiment 1 and Embodiment 2, while such a method is used that the portions of the fine relief structure are removed in the identification pattern region, or the height of the fine relief structure in the identification pattern region is made different from that in the other region, the region where said the portions of the fine relief structure are removed and the region where the height of the fine relief structure is made different from that in the other region may be mixed in the identification pattern region.

Furthermore, a plurality of identification patters may be disposed at random in lieu of one identification pattern.

The present invention is not limited by the above-mentioned embodiments, and various modifications can be made to embodiments according to the present invention in addition to the above-mentioned embodiments.

In addition to the invention as set forth in Claims, the following invention can be extracted from the above-mentioned manufacturing steps shown in FIG. 6.

<Claim a>

A metal mold for forming an optical element by resin molding, the metal mold comprising a fine relief structure formed on a plane through which an object light is transmitted at a pitch smaller than a wavelength band of the object light, wherein a pattern for transferring the fine relief structure to the optical element is formed to have a first metallic layer formed by sputtering processing and a second metallic layer formed by electroforming onto the first metallic layer; and the first metallic layer is formed not only to fill an outline of a pattern of the fine relief structure to be transferred, but also to fill projections and depressions of the fine relief structure to a predetermined depth.

<Claim b>

The metal mold according to Claim a, wherein the first metallic layer is formed so that at least the projections and depressions of the fine relief structure are filled thoroughly with the first metallic layer.

<Claim c>

The metal mold according to Claim a or Claim b, wherein the first and second metallic layers are formed of an identical material.

<Claim d>

A metal mold manufacturing method for forming a metal mold according to any one of Claims a through c, the metal mold manufacturing method comprising the steps of:
a first step for forming a first metallic layer by sputtering on the fine relief structure formed on a non-transfer plane; and
a second step for forming a second metallic layer by electroforming processing on the first metallic layer formed at the first step, wherein
the first metallic layer is formed not only to fill a surface of the fine relief structure, but also to fill the projections and depressions of the fine relief structure to a predetermined depth.

According to each of inventions as claimed in Claims a through d, as mentioned above, total time for formation of the first and second metallic layers can be shortened. Furthermore, since the thickness of the first metallic layer is increased, the electric resistance in the first metallic layer during electroforming is reduced, and since the first metallic layer is formed on the fine relief structure in every hole and corner, such effects that electroforming processing can be performed in a stable fashion are obtained as compared to the case where the first metallic layer is formed only on the surface of the fine relief structure. Furthermore, since the first metallic layer is formed on the fine relief structure in every hole and corner, transfer properties of the fine relief structure to the Ni-layer can be improved as compared to the case where the first metallic layer is formed only on the surface of the fine relief structure. Therefore, the metal mold according to the invention according to any one of Claims a through c eventually results in high formation accuracy of the fine relief structure, and when resin molding is attempted using the metal mold, a stable fine relief structure can be transferred to the optical element, thereby improving properties of the optical element.

The first and the second metallic layers in Claims a through d are specified to be the Ni-layer in the above-mentioned embodiments. The first and the second metallic layers may be formed of other materials.

What is claimed is:

1. An optical element, comprising;
a fine relief structure formed on a plane through which an object light is transmitted at a pitch smaller than a wavelength band of the object light;
the optical element having an identification pattern region in a part of a region where the fine relief structure is formed, in the identification pattern region, in the identification pattern region, a state of formation of the fine relief structure being different from that in other region.

2. The optical element according to claim 1, wherein the fine relief structure is not present in the identification pattern region.

3. The optical element according to claim 1, wherein a height of the fine relief structure in the identification pattern region is different from that in the other region.

4. The optical element according to claim 1, wherein a portion where the fine relief structure is not present and a portion where a height of the fine relief structure is different from that in the other region are mixed in the identification pattern region.

5. The optical element according to claim 1, wherein a width of the identification pattern region in a direction of the pitch is not more than the wavelength band of the object light.

6. The optical element according to claim 1, wherein the width of the identification pattern region in the direction of the pitch is not more than 100 μm.

7. A master prototype used for generating an optical element, the master prototype comprising;
a transfer pattern for transferring and forming a fine relief structure to the optical element, wherein the fine relief structure is transferred and formed directly or through other intermediate product from the transfer pattern on a plane through which an object light for the optical element is transmitted in the optical element, the fine relief structure having a pitch smaller than a wavelength band of the object light;
an identification pattern region is arranged in a part of a region where the fine relief structure is formed, in the identification pattern region, a state of formation of the fine relief structure being different from that in other region.

8. The master prototype according to claim 7, wherein the fine relief structure is not present in the identification pattern region.

9. The master prototype according to claim 7, wherein a height of the fine relief structure in the identification pattern region is different from that in the other region.

10. The master prototype according to claim 7, wherein a portion where the fine relief structure is not present and a portion where the height of the fine relief structure is different from that in the other region are mixed in the identification pattern region.

11. The master prototype according to claim 7, wherein a width of the identification pattern region in a direction of the pitch is not more than the wavelength band of the object light.

12. The master prototype according to claim 7, wherein the width of the identification pattern region in the direction of the pitch is not more than 100 μm.

13. A resin master used for generating an optical element, the resin master comprising;
a transfer pattern for transferring and forming a fine relief structure to the optical element, wherein
the fine relief structure is transferred and formed directly or through other intermediate product from the transfer pattern on a plane through which an object light for the optical element is transmitted in the optical element, the fine relief structure having a pitch smaller than a wavelength band of the object light;
an identification pattern region is arranged in a part of a region where the fine relief structure is formed, in the identification pattern region, a state of formation of the fine relief structure being different from that in other region.

14. The resin master according to claim 13, wherein the fine relief structure is not present in the identification pattern region.

15. The resin master according to claim 13, wherein a height of the fine relief structure in the identification pattern region is different from that in the other region.

16. The resin master according to claim 13, wherein a portion where the fine relief structure is not present and a portion where the height of the fine relief structure is different from that in the other region are mixed in the identification pattern region.

17. The resin master according to claim 13, wherein a width of the identification pattern region in a direction of the pitch is not more than the wavelength band of the object light.

18. The resin master according to claim 13, wherein a width of the identification pattern region in the pitch direction is not more than 100 μm.

19. A resin molded article used for generating an optical element, resin molded article comprising;
a transfer pattern for transferring and forming a fine relief structure to the optical element, wherein
the fine relief structure is transferred and formed directly or through other intermediate product from the transfer pattern on a plane through which an object light for the optical element is transmitted in the optical element, the fine relief structure having a pitch smaller than a wavelength band of the object light;
an identification pattern region is arranged in a part of a region where the fine relief structure is formed, in the identification pattern region, a state of formation of the fine relief structure being different from that in other region.

20. A metal mold used for generating an optical element, the metal mold comprising;
a transfer pattern for transferring and forming a fine relief structure to the optical element, wherein
the fine relief structure is transferred and formed directly from the transfer pattern on a plane through which an object light for the optical element is transmitted in the optical element, the fine relief structure having a pitch smaller than a wavelength band of the object light;
an identification pattern region is arranged in a part of a region where the fine relief structure is formed, in the identification pattern region, a state of formation of the fine relief structure being different from that in other region.
